(19) United States
(12) Patent Application Publication
(10) Pub. No.: US 2015/0113380 A1
(43) Pub. Date: Apr. 23, 2015

(54) SYSTEM AND METHODS FOR MANAGING THE BROADCAST OF CONTENT

(71) Applicants: Edward C. PEIFER, Los Angeles, CA (US); Tarun Sunder Raj, Pasadena, CA (US); Pierre S.W. Drummond, Los Angeles, CA (US)

(72) Inventors: Edward C. PEIFER, Los Angeles, CA (US); Tarun Sunder Raj, Pasadena, CA (US); Pierre S.W. Drummond, Los Angeles, CA (US)

(73) Assignee: THE ICARUS GROUP, LLC, Las Vegas, NV (US)

(21) Appl. No.: 14/060,747

(22) Filed: Oct. 23, 2013

(51) Int. Cl. H04L 29/08; G06F 17/22; G06F 3/0482; G06Q 30/02

(52) U.S. Cl. CPC H04L 67/02; G06Q 30/0277; G06F 17/2247; G06F 3/0482
USPC 715/234

(57) ABSTRACT

A system and machine-implemented method is provided for managing broadcast of content to webpages. In one embodiment, a set of graphical elements is displayed, the display of graphical elements including selectable elements for channels, campaigns, and uniform resource locators (URLs). A set of selections is received based on the set of graphical elements. A set of webpages is identified based on the set of selections received. The set of webpages corresponds to URLs. Each of the webpages includes embed codes that enables the webpages to receive the broadcast of content. The broadcast of content to the identified set of webpages may be controlled. Content may include one or more of advertising content, audio data, video data, multimedia content, interactive media, gaming content, and application data.

### BACKGROUND

The present disclosure relates generally to systems and methods for distribution of content, and, in particular, to managing the broadcast of content to webpages.

The use of online advertisements has become very common. For example, when a user navigates to a webpage, different online advertisements may appear on the webpage. These online advertisements provide a channel from which vendors may solicit business. Online advertisements also provide a forum from which owners of webpages may generate advertising revenues from the vendors. The management of online advertisements, however, has become more difficult as advertising on the web has become more popular, and as the number of webpages to which advertisements can be broadcasted continues to expand.

### SUMMARY

The disclosed subject matter is directed to managing broadcast of content to webpages. In one embodiment, a method for managing broadcast of content includes displaying a set of graphical elements, the set of graphical elements including selectable elements including elements for a plurality of channels, campaigns, and uniform resource locators (URLs); receiving a set of selections based on the set of graphical elements; and identifying a set of webpages based on the set of selections received, the set of webpages corresponding to a plurality of URLs, where each of the webpages includes embed codes that enables the webpage to receive a broadcast of content. The method also includes controlling broadcast of content to the identified set of webpages.

In one embodiment, a computer program product stored on a computer readable medium including computer executable code for managing broadcast of content to webpages is provided. The computer program product includes computer readable code to display a set of graphical elements, the set of graphical elements including selectable elements for a plurality of channels, campaigns, and uniform resource locators (URLs), and to display an option for activation of a broadcast of the content. The computer program product also includes computer readable code to receive a set of selections based on the set of graphical elements, and to identify a set of webpages based on the set of selections received, the set of webpages corresponding to a plurality of URLs, and where each of the webpages includes embed codes that enables the webpage to receive the broadcast of content. The computer program product further includes computer readable code to receive a selection for activation of the broadcast, and to control broadcast of content to the identified set of webpages upon receiving the selection for the activation of the broadcast.

In another embodiment, a device for managing broadcast of content to webpages is provided. The device includes a display and a processor coupled to the display. The display is for presenting a set of graphical elements, the set of graphical elements including selectable elements for a plurality of channels, campaigns, and uniform resource locators (URLs), where each of the plurality of channels comprises an associated set of campaigns, and where each of the plurality of campaigns comprises an associated set of URLs. The processor is configured to receive a set of selections based on the set of graphical elements displayed, where the set of selections include one channel, one campaign, and one or more URLs. The processor is further configured to identify a set of webpages based on the set of selections received, the set of webpages corresponding to the selected one or more URLs, and where each of the identified set of webpages includes embed codes that enables the webpage to receive the broadcast of content. The processor is also configured to control broadcast of content to the identified set of webpages.

In another embodiment, method for managing broadcast of content to webpages includes receiving a request for data associated with an embed code of a client webpage, wherein the request is received by a process request module of a device, and determining an active campaign for the webpage by a channel campaigns module of the device based at least in part on the request received by the process request module. The method also includes building content by a build request module of the device based on the active campaign determined for the webpage, wherein the build request module builds content based at least in part on a set of selections for one or more of a plurality of channels, a plurality of campaigns, and a plurality of uniform resource locators (URLs), and identification of a set of webpages based on the set of selections, the set of webpages corresponding to a plurality of URLs, wherein each of the webpages in the set of webpages includes embed codes to enable a webpage to receive a broadcast of content. The method also includes controlling broadcast of content to the client webpage.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an exemplary network environment for managing the broadcast of content on the web according to one or more embodiments.

FIG. 2 illustrates a graphical representation of elements for managing the broadcast of content according to one or more embodiments.

FIG. 3 illustrates a method for managing the broadcast of content according to one or more embodiments.

FIG. 4 illustrates an exemplary flow diagram for managing the broadcast of content for a particular channel according to one or more embodiments.

FIG. 5 illustrates a graphical representation of a user interface for managing the broadcast of content according to one or more embodiments.

FIG. 6 illustrates a device for managing the broadcast of content according to one or more embodiments.

FIG. 7 illustrates a method for managing the broadcast of content according to one or more embodiments.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology.

However, the subject technology is not limited to the specific details set forth herein and may be practiced without these specific details. In some instances, structures and components are shown in block diagram form in order to avoid obscuring the concepts of the subject technology.

One aspect of the disclosure relates to managing the broadcast of content to numerous webpages. As used herein, content may relate to one or more of advertising content, audio data, video data, multimedia content, interactive media, gaming content, application data, etc. While one or more embodiments are described below as relating to or including advertising content, it should be appreciated that the embodiments are not limited to advertising content. In addition, the embodiments described herein are may include or broadcast other types of content.

In one embodiment, a method for managing broadcast of advertising content includes presenting a user interface to allow for selection and distribution of advertising content. The method may present a set of graphical elements from which selections may be made. The set of graphical elements may include selectable elements for a plurality of channels, campaigns, and URLs. As used herein, a “channel” refers to a first order category, and a “campaign” refers to a second order category from which a user may select. A “URL,” as used herein, refers to a string of text and symbols that corresponds to a webpage. Each channel comprises one or more campaigns, and each campaign comprises one or more URLs. Examples of channels, campaigns, and URLs are provided below. In one embodiment, a selection of one of the channels produces a set of campaigns from which to select, and a selection of one of the campaigns from the set of campaigns produces a set of URLs.

A set of webpages is identified based on the selections, and advertising content is broadcasted to webpages based on selections from the set or URLs. That is, advertising content is broadcasted to webpages corresponding to a selected set of URLs from the graphical elements displayed. The webpages corresponding to the plurality of URLs include embed codes that enable the webpages to receive the broadcast of advertising content. The advertising content broadcasted to the webpages may be modified, and the modifications to the advertising content may be broadcasted to the webpages in real time. Changes to the advertising content may be made without changing the embed code on that particular webpage. For example, image and/or text files corresponding to advertising content may be modified on one or more servers hosting the files. Thus, advertising content broadcasted from the server will reflect the changes made to the files.

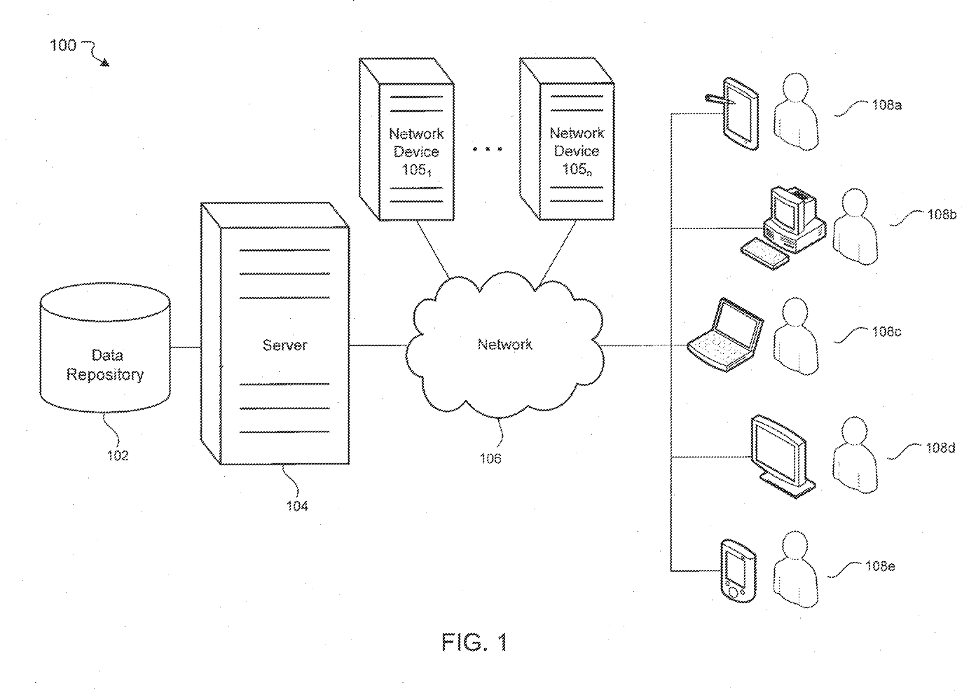

FIG. 1 illustrates an exemplary network environment for managing the broadcast of advertising content on the web. The computing system can include clients and servers. A client and server are generally remote from each other and typically interact through a communication network. The relationship of client and server arises due to computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Network environment 100 includes a data repository 102 (e.g., computer-readable storage media) for storing a variety of data accessible by web-based applications. While the network environment 100 includes a single data repository 102 in FIG. 1, certain embodiments of the network environment may include additional data repositories. Data repository 102 may store data files associated with advertisements, such as files containing advertising content to be broadcasted, including image files, text files, hyperlinks, etc.

Network environment 100 further includes server 104. While the network environment 100 includes a single server in FIG. 1, the network environment may include several interconnected servers in some implementations. Server 104 may populate image content corresponding to different business establishments. In some exemplary embodiments, server 104 can be a single computing device, such as a computer server. In other embodiments, server 104 can represent a plurality of computing devices working together to provide network data and communications (e.g., cloud computing). Server 104 and client devices 108a-108e may be communicatively coupled through a network 106.

In some implementations, client devices 108a-108e may request data from server 104. For example, client devices 108a-108e may navigate to a webpage on which advertising content may broadcasted. In order to broadcast the advertising content, server 104 retrieves content and serves it to client devices 108a-108e via network 106. Server 104 may be configured to communicate with one or more network elements configured to host a web page, such as network devices 105₁-105ₙ. For example, server 104 may retrieve advertising content from network devices 105₁-105ₙ, and control what content is served to the webpages. The server hosting the webpage will typically be different than the server updating/distributing the advertising content.

Each of client devices 108a-108e represents various forms of processing devices. Examples of a processing device include a desktop computer, a laptop computer, a handheld computer, a television coupled to a processor or having a processor embedded therein, a personal digital assistant (PDA), a network appliance, a camera, a smart phone, a media player, a navigation device, an email device, a game console, or a combination of any these data processing devices or other data processing devices.

Each of client devices 108a-108e relate to devices configured for network communications, such as a device having a processor, a memory, and communications capability for providing content to the electronic devices. Each of network devices 105₁-105ₙ can represent various forms of servers including, but not limited to a web server, an application server, a proxy server, a network server, or a server farm. In some aspects, client devices 108a-108e may communicate wirelessly through a communication interface (not shown), which may include digital signal processing circuitry where necessary. The communication interface may provide for communications under various modes or protocols. In some aspects, each client (e.g., client devices 108a-108e) can communicate with servers 104 via a virtual private network (VPN), Secure Shell (SSH) tunnel, or other secure network connection. In some aspects, network 106 may further include a corporate network (e.g., intranet) and one or more wireless access points.

According to one embodiment, network environment 100 can be a distributed client/server system that spans one or more networks such as network 106. Network 106 can be a large computer network, including a local area network (LAN), wide area network (WAN), the Internet, a cellular network, or a combination thereof connecting any number of mobile clients, fixed clients, and servers.

In exemplary embodiments, server 104 may broadcast advertising content to several webpages. For example, when server 104 receives a request to launch or modify an advertisement campaign, server 104 may retrieve advertising content (e.g., images, text, hyperlinks, etc.) from data repository 102 and broadcast advertising content to selected webpages on network 106. The advertising content is displayed on client devices 108a-108e when any of client devices 108a-108e navigates a webpage corresponding to one of the selected URLs. Server 104 may also receive control commands that modify the broadcast of the advertising content on network 106.

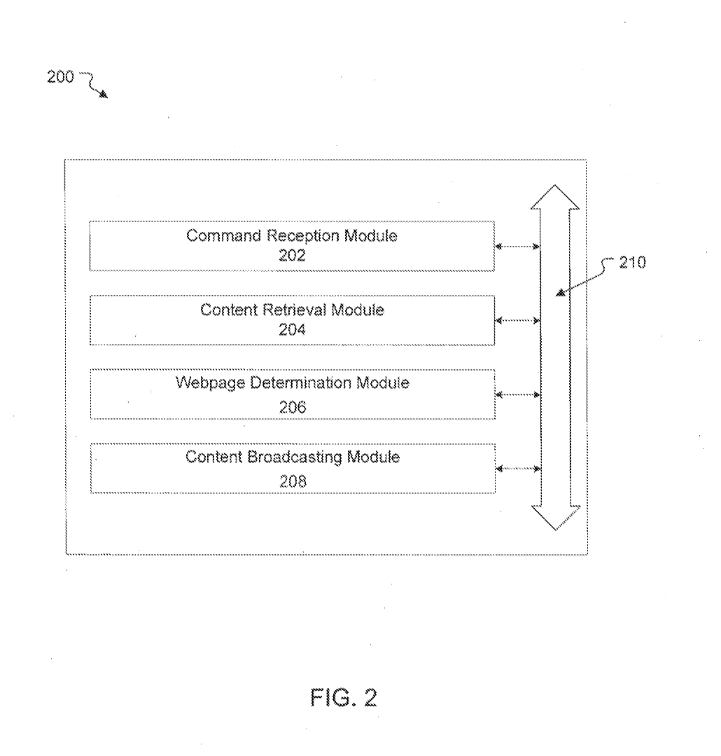

FIG. 2 illustrates a graphical representation of modules for managing the broadcast of advertising content according to one or more embodiments. System 200 includes command reception module 202, content retrieval module 204, webpage determination module 206, and content broadcasting module 208, which may be included in server 104 to perform the operations described below. Each of these modules is communicatively coupled to one another via bus 210. The modules process commands received from one or more of client devices 108a-108e, and manage the broadcast of advertising content. For example, command reception module 202 may receive instructions from one of client devices 108a-108e to broadcast certain advertising content to certain webpages when a user desires to launch a particular advertising campaign. The instructions received may include selection of certain channels on which the user desires to advertise, and selections of campaigns corresponding to the selected channels. The user may also send instructions relating to specific webpages to which the user desires to broadcast the advertising content by selecting URLs that correspond to these webpages.

Based on the instructions received by command reception module 202, content retrieval module 204 retrieves the corresponding advertising content from a data repository (e.g., data repository 102 and/or one of network devices 105₁-105ₙ). Once the content has been retrieved, webpage determination module 206 determines, based on the received instructions, which webpages to broadcast the advertising content. Content broadcasting module 208 may then broadcast the advertising content to determined webpages via network 106. The webpages to which the advertisement is broadcasted include certain embed codes that permit the webpages to receive the broadcasted content. Absent the embed codes, the advertising content will not be displayed on the webpage.

In some embodiments, the modules of FIG. 2 may be implemented in computer readable code or software (e.g., subroutines, code, etc.). The software implementation of the modules may operate on server 104. In some aspects, some or all of the modules may be implemented in hardware (e.g., an Application. Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

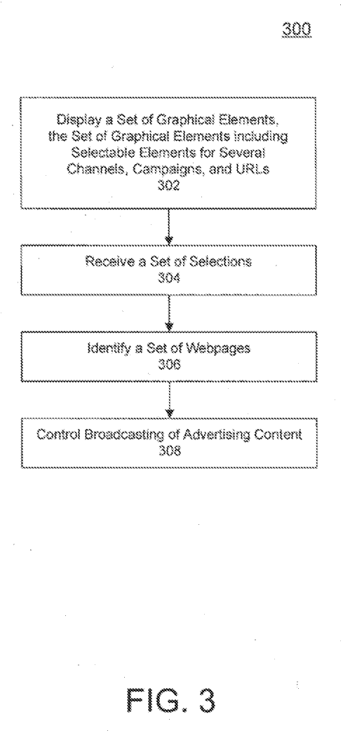

FIG. 3 illustrates a method for managing the broadcast of advertising content according to one or more embodiments. The management of the broadcast of advertising content is performed via user interactions on a graphical user interface. In block 302, a set of graphical elements is displayed. The set of graphical elements may include selections from several channels, campaigns, and URLs. In some aspects, each of the channels may include campaigns as subcategories, and each of the campaigns may include a set of URLs.

In block 304, a set of selections is received by command reception module 202 based on the set of graphical elements displayed. Based on the selection, a set of campaigns associated with the selected channel is displayed. Channels and campaigns provide groupings to select webpages and to direct advertising content, and campaigns serve as subcategories for a particular channel. For example, a channel may be represented by a particular interest group, such as one or more of sports, news, entertainment, etc. Campaigns corresponding to a channel may provide more specific subcategories from which the user may choose. For example, a selection of a channel for sports may cause a set of campaigns to be presented. These campaigns presented may include subcategories such as different types of sports, different geographic locations of sports teams, etc.

Once a campaign has been further selected, then a set of URLs associated with the selected campaign is presented. Each of the URLs presented can represent a different webpage. The webpages represented by the URLs are the destination pages to which the advertising content is to be broadcasted. In some aspects, each of the URLs is unique to a specific channel. For example, if a URL is included in a campaign associated with a particular channel, then the URL cannot be included in any campaigns associated with any other channels. In other words, no one URL may be displayed in two different channels.

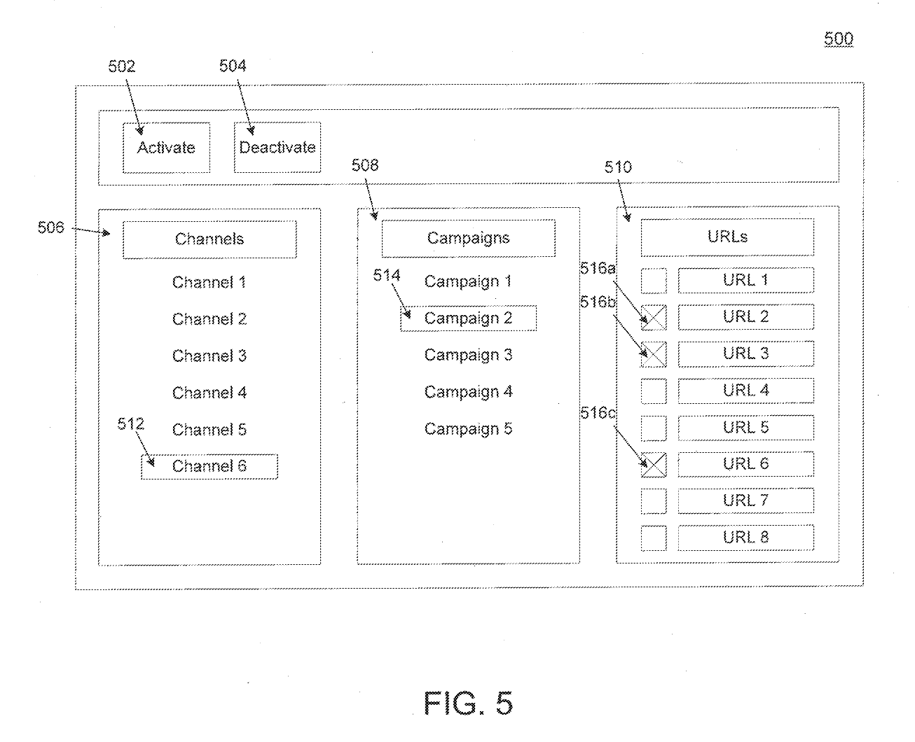

According to one embodiment, selection of one or more of the URLs may be made from the URLs presented via checkboxes. For example, and as will be described below in FIG. 5, a checkbox may be presented with each of the URLs in order for selections/deselections of the checkboxes associated with URLs to be made. A selection of a checkbox indicates that the advertising content is to be broadcasted to a webpage associated with the corresponding URL. Similarly, not selecting a checkbox indicates that the advertising content is not to be broadcasted to a webpage associated with the corresponding URL.

Once the set of selections (of the channel, campaign, and associated URLs) has been received, a set of webpages is identified based on the received selections in block 306. Each of the webpages corresponds to one of the URLs. Each of the webpages corresponding to the URLs also includes an embed code that enable the webpage to receive the broadcasted advertising content. In certain embodiments, absent the embed codes, the advertising content will not be displayed on the webpage. The broadcast of advertising content to the identified set of webpages is controlled in block 308. In some aspects, an option for activating the control of the broadcast of advertising content may be displayed, where control of the broadcast of advertising content to webpages is initiated upon receiving a selection for activating the broadcast of the advertising content.

In some embodiments, the advertising content is determined independent of the embed code. For example, different webpages to which the advertising content is to be broadcasted may include the same embed code. Thus, when a broadcast of advertising content is made, the different webpages corresponding to selected URLs will receive the same advertising content. According to another embodiment, if the advertising content is modified, the different webpages to which the advertising content is broadcasted will reflect the modification in advertising content. This modification of content may be made in real time and without altering the embed code. Thus, it will not be required that all the embed codes associated with the webpages be changed in order to change the content to be displayed on the webpages. Simply modifying the advertising content and initiating a broadcast at a central location will cause all webpages corresponding to selected URLs to receive the modified content.

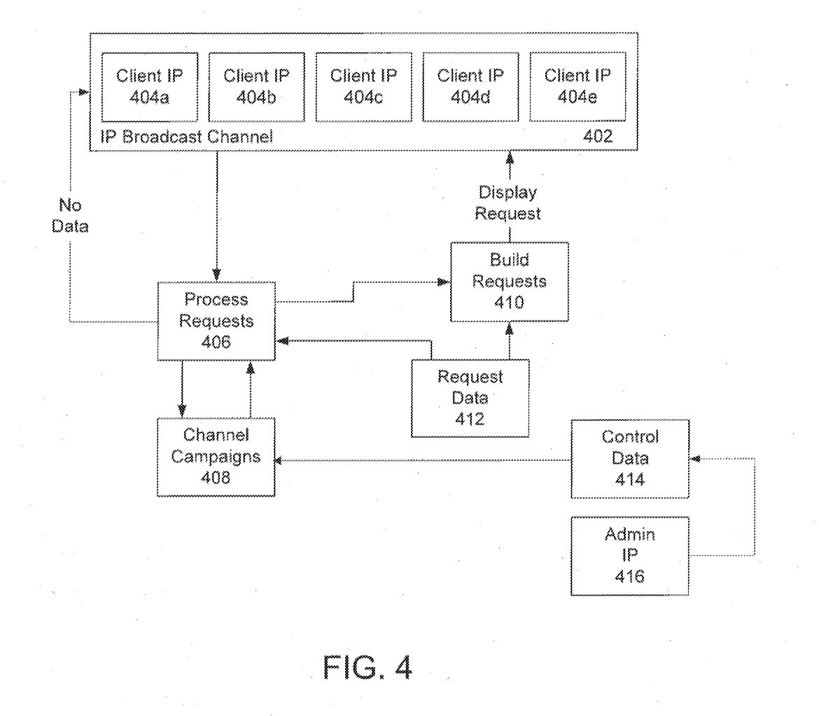

FIG. 4 illustrates an exemplary flow diagram for managing the broadcast of advertising content for a particular channel according to one or more embodiments. Each of the modules described herein may reside on server 104, at which instructions are received and from which the broadcast of advertising content is controlled. Internet Protocol (IP) broadcast channel 402 includes several client Internet Protocols (IPs) represented in FIG. 4 by client IP 404a-e. When one of the client IPs navigates to a page on which an embed code resides, an external request is initiated by the client IP. IP broadcast channel module 402 sends the external request as an encrypted string to process requests module 406. In response to the request, process requests module 406 retrieves the active campaign from channel campaigns module 408.

Based on process requests module 406, channel campaigns module 408 determines whether any advertising content is running on the campaign requested. If no advertising content is running on the campaign requested, then channel campaigns module 408 will respond to process requests module 406 with no data. As a result, no data is returned from process requests module 406 to the requesting client IP. If an active campaign exists, channel campaigns module 408 receives a command from control data module 414 to return certain campaign data to process requests module 406. When process requests module 406 receives this data from channel campaigns module 408, a command is sent to build request module 410, prompting the build request module 410 to build the advertising content and provide the content for display on the requesting client IP.

In some embodiments, request data module 412 examines the encrypted string that is received from the requesting client IP in order to identify the active campaigns for a particular channel. If no campaigns are active, request data module 412 will send a command to process requests module 406 to respond with no data to the requesting client IP. If an active campaign exists on the channel, request data module 412 will send instructions to process requests module 406 to have channel campaigns module 408 pull data related to that channel from control data module 414.

In some embodiments, an administration module, admin IP module 416, sets the output of control data module 414 based on a received command. Thus, the data pulled from control data module 414 may be managed by admin IP 416. The data pulled from control data module 414 is subsequently received by process requests module 406 and forwarded to build request module 410. The build request module 410 builds the advertising content and provides the content for display on the requesting client IP.

FIG. 5 illustrates a graphical representation of a user interface 500 that device for managing the broadcast of advertising content according to one or more embodiments. User interface 500 may be displayed on a display device. The activation of a broadcast of the advertising content to webpages may be controlled by activation button 502 and deactivation button 504. Upon receiving a selection of activation button 502, the advertising content is broadcast to selected webpages. Conversely, a selection of deactivation button 504 suspends the broadcast of the advertising content to the selected webpages.

In order for a user to manage the broadcast of advertising content, a selection of channels is provided in channel box 506. A selection of one of the channels may be made from channel box 506. In FIG. 5, for example, Channel 6 has been selected from the six channels, as shown by box 512. While this example shows only six channels in channel box 506, any number of channels may be presented for selection.

Upon selecting Channel 6, the graphical representation can populate campaign box 508 with a number of different campaigns that are associated with Channel 6. In this example, campaign box 508 is populated with five campaigns that are associated with Channel 6; however, the number of campaigns may vary between the different channels. Each campaign in campaign box 508 further corresponds to a set of URLs. In this example, Campaign 2 has been selected from the different campaigns, as indicated by box 514. The selection of Campaign 2 subsequently produces eight different URLs that correspond to Campaign 2. Each of the URLs displayed corresponds to a webpage to which the advertising content is to be broadcasted. In some aspects, the URLs displayed are unique to the particular channel to which the selected campaign is associated. That is, no URL may exist in more than one channel.

As shown in FIG. 5, multiple URLs may be chosen via checkboxes. In this example, URL 2, 3, and 6 have been selected, as indicated by 516a-516c. The selection of the channel, campaign, and URLs indicates that the user desires to broadcast advertising content to Channel 6, Campaign 2, and URLs 2, 3, and 6.

Channels and campaigns provide groupings so that a user may narrow down the webpages to which the user would like to direct the advertising content. For example, a channel may be represented by human interest groups, such as sports, news, entertainment, etc. And for each channel, a variety of campaigns may exist. Once a campaign is selected, then the user may further narrow the broadcast of advertising content by selecting URLs. Each of the URLs represents a different webpage, and the webpages represented by the URLs are the destination pages to which the advertising content is to be broadcasted. Each of the webpages corresponding to the URLs may include an embed code that enable the webpage to receive the broadcasted advertising content.

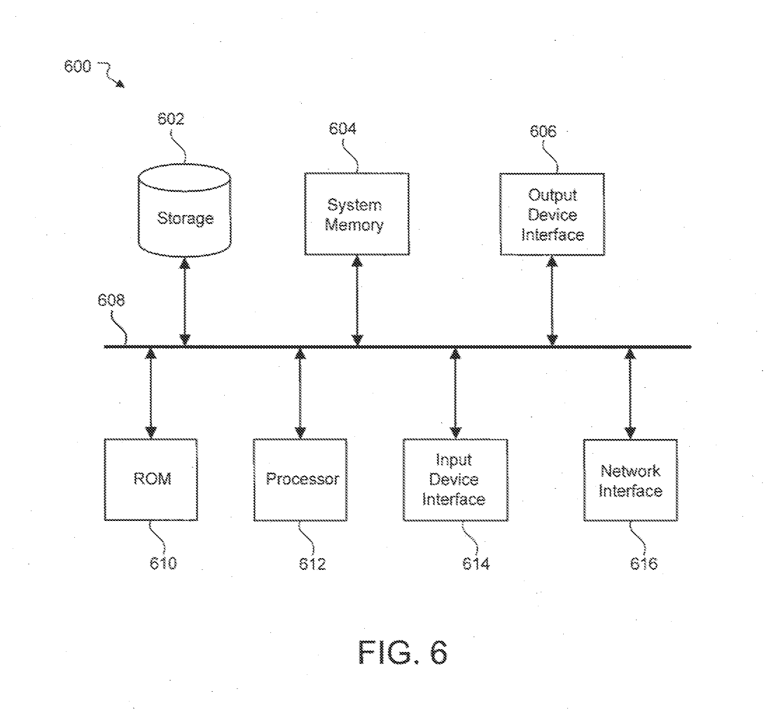

FIG. 6 illustrates a device for managing the broadcast of advertising content according to one or more embodiments. Device 600 can be a computer, phone, PDA, or any other sort of electronic device. Such an electronic system includes various types of computer readable media and interfaces for various other types of computer readable media. Device 600 includes a bus 608, processing unit(s) 612, a system memory 604, a read-only memory (ROM) 610, a permanent storage device 602, an input device interface 614, an output device interface 606, and a network interface 616.

Bus 608 collectively represents all system, peripheral, and chipset buses that communicatively connect the numerous internal devices of device 600. For instance, bus 608 communicatively connects processing unit(s) 612 with ROM 610, system memory 604, and permanent storage device 602.

From these various memory units, processing unit(s) 612 retrieves instructions to execute and data to process in order to execute the processes of the subject disclosure. The processing unit(s) can be a single processor or a multi-core processor in different implementations.

ROM 610 stores static data and instructions that are needed by processing unit(s) 612 and other modules of the electronic system. Storage device 602 is a read-and-write memory device that stores instructions and data even when device 600 is off. Some implementations of the subject disclosure use a mass-storage device (such as a magnetic or optical disk and its corresponding disk drive) as storage device 602.

Like storage device 602, system memory 604 is a read-and-write memory device. However, unlike storage device 602, system memory 604 is a volatile read-and-write memory, such as random access memory. System memory 604 stores some of the instructions and data that the processor needs at runtime. In some implementations, the processes of the subject disclosure are stored in system memory 604, permanent storage device 602, and/or ROM 610. For example, the various memory units include instructions for managing the broadcast of advertising content on the web. From these various memory units, processing unit(s) 612 retrieves instructions to execute and data to process in order to execute the processes of some implementations.

Bus 608 also connects to input and output device interfaces 614 and 606. Input device interface 614 enables the user to communicate information and select commands to the electronic system. Input devices used with input device interface 614 include, for example, alphanumeric keyboards and pointing devices (also called “cursor control devices”). Output device interface 606 enables the display of images generated by the device 600. For example, output device 606 can enable a graphical user interface to be displayed on a display device. Output device 606 can also enable the broadcast of advertising content to other devices.

Finally, as shown in FIG. 6, bus 608 also couples device 600 to a network (not shown) through a network interface 616. In this manner, the computer can be a part of a network of computers, such as a local area network, a wide area network, or an Intranet, or a network of networks, such as the Internet. Any or all components of device 600 can be used in conjunction with the subject disclosure.

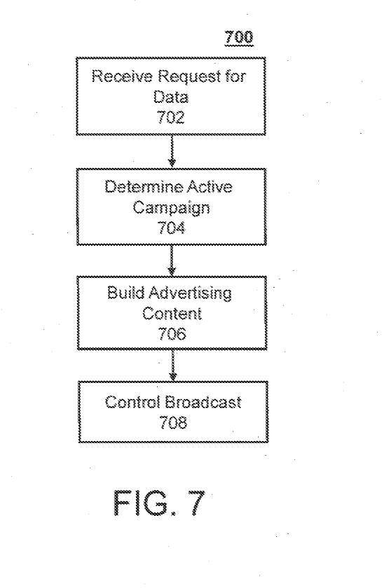

FIG. 7 illustrates a method for managing the broadcast of advertising content according to one or more embodiments. In one embodiment, a network device (e.g., server 104) may be configured to manage the activation, or deactivation, of advertising content. Method 700 may be performed by a device, and/or one or more modules (e.g., modules of FIG. 4) of a device. According to another embodiment, method 700 may be initiated by receiving a request for data associated with an embed code of a client webpage, wherein the request is received by a process request module of a device in block 702. The request may be an external request formatted as an encrypted string. In some aspects, each of the channels may include campaigns as subcategories, and each of the campaigns may include a set of URLs. In certain embodiments, an encrypted string received from a requesting device may be examined by a request data module in order to identify active campaigns for a channel.

In block 704, an active campaign may be determined for the webpage by a channel campaigns module of the device based at least in part on the request received by the process request module. The channel campaigns module determines whether advertising content is running on a requested campaign. The process requests module receives data from the channel campaigns module when an active campaign is determined by the channel campaigns module. In certain embodiments, instructions may be sent by an active campaigns request data module to the process requests module to instruct the channel campaigns module to pull data related to a channel from a control data module.

In block 706, advertising content may be built by a build request module of the device based on the active campaign determined for the webpage. The build request module builds advertising content based at least in part on a set of selections for one or more of a plurality of channels, a plurality of campaigns, and a plurality of uniform resource locators (URLs), and identification of a set of webpages based on the set of selections, the set of webpages corresponding to a plurality of URLs, wherein each of the webpages in the set of webpages includes embed codes to enable a webpage to receive a broadcast of advertising content. An admin IP module of the device may set output of a control data module to a build request module for determining advertising content and providing content for display to a requesting client.

In block 708, broadcast of advertising content to a client webpage may be controlled. Broadcasting can include transmission of content for display by a client webpage.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions.

A computer program (also known as a program, software, software application, script, or code) can be written in any form of programming language, including compiled or interpreted languages, declarative or procedural languages. A computer program may, but need not, correspond to a file in a file system. A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media).

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

What is claimed is:

1. A method for managing broadcast of content to webpages comprising:
displaying, by a device, a set of graphical elements, the set of graphical elements including selectable elements for a plurality of channels, a plurality of campaigns, and a plurality of uniform resource locators (URLs);
receiving, by the device, a set of selections based on the set of graphical elements;
identifying, by the device, a set of webpages based on the set of selections received, the set of webpages corresponding to a plurality of URLs, and wherein each of the webpages includes embed codes that enables the webpage to receive a broadcast of content; and
controlling, by the device, broadcast of content to the identified set of webpages.

2. The method of claim 1, wherein each of the set of graphical elements includes at least one of a set selectable icon or clickable text.

3. The method of claim 1, wherein the content is determined independent of the embed codes of the webpages.

4. The method of claim 3, wherein the content is modifiable, and wherein controlling broadcast of the content includes controlling broadcast of modifications to the content in real time.

5. The method of claim 1, wherein each of the plurality of channels is associated with a set of campaigns, and wherein displaying the set of graphical elements further includes displaying selectable elements for a set of campaigns based on a selection of one of the plurality of channels.

6. The method of claim 5, wherein each of the plurality of campaigns is associated with a set of URLs, and wherein displaying the set of graphical elements further includes displaying selectable elements for a set of URLs based on a selection of one of the plurality of campaigns.

7. The method of claim 6, wherein each of the URLs is unique to one of the plurality of channels.

8. The method of claim 6, wherein the set of campaigns associated with a particular channel and the set of URLs associated with a particular campaign are modifiable.

9. The method of claim 6, wherein one or more URLs is selectable from the associated set of URLs.

10. The method of claim 9, wherein controlling broadcast of content to the identified set of webpages includes controlling broadcast of content to webpages corresponding to the one or more URLs selected from the associated set of URLs.

11. The method of claim 1, wherein the content includes one or more of advertising content, audio data, video data, multimedia content, interactive media, gaming content, and application data.

12. The method of claim 1, wherein:
displaying the set of graphical elements further includes displaying a graphical element for an option for activation of a broadcast of the content; and
receiving the set of selections based on the set of graphical elements further comprises receiving a selection of the graphical element for the activation of the broadcast of the content, wherein the control of the broadcast of content is activated upon receiving the selection of the graphical element for the activation of the broadcast of the content.

13. A computer program product stored on a computer readable medium including computer executable code for managing broadcast of content to webpages, the computer program product comprising:
computer readable code to display a set of graphical elements, the set of graphical elements including selectable elements for a plurality of channels, a plurality of campaigns, and a plurality of uniform resource locators (URLs);
computer readable code to display an option for activation of a broadcast of the content;
computer readable code to receive a set of selections based on the set of graphical elements;
computer readable code to identify a set of webpages based on the set of selections received, the set of webpages corresponding to a plurality of URLs, and wherein each of the webpages includes embed codes that enables the webpage to receive the broadcast of content;
computer readable code to receive a selection for activation of the broadcast; and
computer readable code to control broadcast of content to the identified set of webpages upon receiving the selection for the activation of the broadcast.

14. The computer program product of claim 13, wherein the content is determined independent of the embed codes of the webpages.

15. The computer program product of claim 14, wherein the content is modifiable, and wherein the computer readable code to control broadcast of the content includes computer readable code to control broadcast of modifications to the content in real time.

16. The computer program product of claim 13, wherein each of the plurality of channels is associated with a set of campaigns, and wherein computer readable code to display the set of graphical elements further includes computer readable code to display selectable elements for a set of campaigns based on a selection of one of the plurality of channels.

17. The computer program product of claim 16, wherein each of the plurality of campaigns is associated with a set of URLs, and wherein computer readable code to display the set of graphical elements further includes computer readable code to display selectable elements for a set of URLs based on a selection of one of the plurality of campaigns.

18. The computer program product of claim 17, wherein each of the URLs is unique to one of the plurality of channels, and wherein one or more URLs is selectable from the associated set of URLs.

19. The computer program product of claim 13, wherein the content includes one or more of advertising content, audio data, video data, multimedia content, interactive media, gaming content, and application data.

20. A device for managing broadcast of content to webpages, the device comprising:
a display for presenting a set of graphical elements, the set of graphical elements including selectable elements for a plurality of channels, a plurality of campaigns, and a plurality of uniform resource locators (URLs), wherein each of the plurality of channels comprises an associated set of campaigns, and wherein each of the plurality of campaigns comprises an associated set of URLs; and
a processor coupled to the display, the processor configured to:
receive a set of selections based on the set of graphical elements displayed, wherein the set of selections include one channel, one campaign, and one or more URLs;
identify a set of webpages based on the set of selections received, the set of webpages corresponding to the selected one or more URLs, and wherein each of the identified set of webpages includes embed codes that enables the webpage to receive the broadcast of content; and
control broadcast of content to the identified set of webpages.

21. The device of claim 20, wherein the content is determined independent of the embed codes of the webpages.

22. The device of claim 20, wherein the content is modifiable, and wherein the processor configured to control broadcast of the content is further configured to control broadcast of modifications to the content in real time.

23. The device of claim 20, wherein the content includes one or more of advertising content, audio data, video data, multimedia content, interactive media, gaming content, and application data.

24. A method for managing broadcast of content to webpages comprising:
receiving a request for data associated with an embed code of a client webpage, wherein the request is received by a process request module of a device;
determining an active campaign for the webpage by a channel campaigns module of the device based at least in part on the request received by the process request module;
building content by a build request module of the device based on the active campaign determined for the webpage, wherein the build request module builds content based at least in part on
a set of selections for one or more of a plurality of channels, a plurality of campaigns, and a plurality of uniform resource locators (URLs), and
identification of a set of webpages based on the set of selections, the set of webpages corresponding to a plurality of URLs, wherein each of the webpages in the set of webpages includes embed codes to enable a webpage to receive a broadcast of content; and
controlling broadcast of content to the client webpage.

25. The method of claim 24, wherein the request is an external request formatted as an encrypted string.

26. The method of claim 24, wherein the channel campaigns module determines whether content is running on a requested campaign.

27. The method of claim 24, wherein the set of selections each are associated with graphical elements includes at least one of a set selectable icon or clickable text.

28. The method of claim 24, wherein broadcasting includes transmission of content for display by a client webpage.

29. The method of claim 24, further comprising sending instructions by an active campaigns request data module to the process requests module to instruct the channel campaigns module to pull data related to a channel from a control data module.

30. The method of claim 24, further comprising setting, by an administration module of the device, output of a control data module to a build request module for determining content and providing content for display to a requesting client.

31. The method of claim 24, wherein the content includes one or more of advertising content, audio data, video data, multimedia content, interactive media, gaming content, and application data.
